(19) United States
(12) Patent Application Publication
(10) Pub. No.: US 2021/0312161 A1
(43) Pub. Date: Oct. 7, 2021

(54) VIRTUAL IMAGE LIVE BROADCAST METHOD, VIRTUAL IMAGE LIVE BROADCAST APPARATUS AND ELECTRONIC DEVICE

(71) Applicant: GUANGZHOU HUYA INFORMATION TECHNOLOGY CO., LTD., Guangdong (CN)

(72) Inventors: Hao WU, Guangdong (CN); Jie XU, Guangdong (CN); Yongfeng LAN, Guangdong (CN); Zheng LI, Guangdong (CN)

(73) Assignee: GUANGZHOU HUYA INFORMATION TECHNOLOGY CO., LTD., Guangdong (CN)

(21) Appl. No.: 17/264,546

(22) PCT Filed: Mar. 27, 2020
(86) PCT No.: PCT/CN2020/081625

§ 371 Date: Jan. 29, 2021

(30) Foreign Application Priority Data
Mar. 29, 2019 (CN) 201910252004.1

(51) Int. Cl. G06K 9/00; H04N 21/44; H04N 21/2187; H04N 21/4784; H04N 21/488

(52) U.S. Cl. CPC G06K 9/00255; G06K 9/00241; G06K 9/00281; H04N 21/4886; H04N 21/2187; H04N 21/4784; H04N 21/44008

(57) ABSTRACT

The present disclosure provides a virtual avatar live streaming method, a virtual avatar live streaming apparatus and an electronic device, which relates to the field of online live streaming technology. Firstly, an image of an anchor is acquired by an image acquiring device, then a face detection is performed on the image, and in response a facial image is detected in the image, a plurality of facial feature points of the facial image are extracted; at last, a facial state of the virtual avatar is controlled based on the plurality of facial feature points and a plurality of facial models pre-built for the virtual avatar.

### CROSS REFERENCE TO RELATED APPLICATION

The present disclosure claims priority to Chinese Patent Application No. 201910252004.1, filed with the Chinese Patent Office on Mar. 29, 2019 and entitled ‘VIRTUAL AVATAR LIVE STREAMING METHODS, VIRTUAL AVATAR LIVE STREAMING APPARATUSES AND ELECTRON DEVICES’, which is incorporated herein by reference in its entirety.

### TECHNICAL FIELD

This present disclosure relates to the field of online live streaming technology, and in particular to virtual avatar live streaming methods, virtual avatar live streaming apparatuses and electronic devices.

### BACKGROUND

In order to enhance the interest of online live streaming, in some implementations, a virtual avatar, instead of the actual image of the anchor, is displayed in a live screen.

However, in some implementations, the facial state appearance of the avatar in a live streaming scene is relatively single, and it is difficult to express the actual performance of the anchor. Therefore, there is a problem of relatively bad experience for a user watching the displayed avatar, and relatively weak sense of interaction.

### SUMMARY

The purposes of the present disclosure are to provide a virtual avatar live streaming method, a virtual avatar live streaming apparatus and an electronic device, which ensures high consistency between the facial state of the virtual avatar and the actual state of the anchor.

In order to achieve at least one of the above purposes, the methods provided in the present disclosure are as follows:

A virtual avatar live streaming method is provided in the present disclosure, which is applicable to a live streaming device configured to control a virtual avatar displayed in a live streaming screen. The method includes: acquiring a video frame of an anchor by an image acquiring device; performing a face detection on the video frame, and in response to that a facial image is detected in the video frame, performing a feature extraction on the facial image to obtain a plurality of facial feature points; controlling a facial state of the virtual avatar based on the plurality of facial feature points and a plurality of facial models pre-built for the virtual avatar.

In an example, controlling a facial state of the virtual avatar according to the plurality of facial feature points and a plurality of facial models pre-built for the virtual avatar includes: obtaining a current facial information set of the anchor based on the plurality of facial feature points; based on the current facial information set, obtaining a target facial model corresponding to the current facial information set from the plurality of facial models pre-built for the virtual avatar; and controlling the facial state of the virtual avatar based on the target facial model.

In an example, based on the current facial information set, obtaining a target facial model corresponding to the current facial information set from the plurality of facial models pre-built for the virtual avatar includes: obtaining the target facial model corresponding to the current facial information set based on a pre-established correspondence in which facial models correspond to respective facial information sets.

In an example, based on the current facial information set, obtaining a target facial model corresponding to the current facial information set from the plurality of facial models pre-built for the virtual avatar includes: determining a matching degree of the current facial information set with respect to each of the plurality of facial models, determining a facial model for which the matching degree satisfies a preset condition as the target facial model corresponding to the current facial information set.

In an example, controlling the facial state of the virtual avatar based on the target facial model includes: rendering the facial image of the virtual avatar based on the target facial model.

In an example, the method further includes: determining a target feature point to be extracted in the feature extraction.

In an example, determining the target feature point to be extracted in the feature extraction includes: acquiring a plurality of facial images of the anchor in different facial states, and selecting one of the facial images as a reference image; extracting a preset number of facial feature points comprised in each of the facial images based on a preset feature extraction method; for each of the facial images, comparing the extracted facial feature points in the facial image with the extracted facial feature points in the reference image, so as to obtain respective change values of the facial feature points in the facial image with respect to the facial feature points in the reference image; determining a facial feature point of which the change value is greater than a preset threshold as the target feature point to be extracted in the feature extraction.

In an example, determining the target feature point to be extracted in the feature extraction includes: determining a number of target feature points to be extracted in the feature extraction based on historical live streaming data of the anchor.

In an example, the historical live streaming data include one or more of: a number of virtual gifts to the anchor; a live streaming duration of the anchor; a number of bullet-screen comments for the anchor, and a level of the anchor.

In an example, the facial image is a depth image which comprises position information and depth information for each of the facial feature points.

A virtual avatar live streaming apparatus is also provided by the present disclosure, which is applicable to a live streaming device configured to control a virtual avatar displayed in a live streaming screen. The apparatus includes: a video frame acquiring module, configured to acquire a video frame of an anchor by an image acquiring device; a feature point extracting module, configured to perform a face detection on the video frame, and in response to that a facial image is detected in the video frame, perform a feature extraction on the facial image to obtain a plurality of facial feature points; a facial state controlling module, configured to control a facial state of the virtual avatar based on the plurality of facial feature points and a plurality of facial models pre-built for the virtual avatar.

An electronic device is also provided in the present disclosure, which includes a memory, a processor and a computer program stored in the memory and capable of executing on the processor, when the computer program is executed on the processor, steps in the virtual avatar live streaming methods are implemented.

A computer-readable storage medium is also provided in the present disclosure. The computer-readable storage medium stores a computer program. When the computer program is executed, steps in the virtual avatar live streaming methods are implemented.

### BRIEF DESCRIPTION OF THE DRAWINGS

FIG. 1 is a schematic system block diagram of a live streaming system according to the embodiments of the present disclosure.

FIG. 2 is a schematic block diagram of an electronic device according to the embodiments of the present disclosure.

FIG. 3 is a schematic flowchart of a method of a virtual avatar live streaming method according to the embodiments of the present disclosure.

FIG. 4 is a schematic flowchart of the sub-steps included in step S150 in FIG. 3.

FIG. 5 is a schematic flowchart for determining target feature points according to the embodiments of the present disclosure.

FIG. 6 is a schematic diagram of facial feature points according to the embodiments of the present disclosure.

FIG. 7 is another schematic diagram of facial feature points according to the embodiments of the present disclosure.

FIG. 8 is a schematic block diagram of the functional modules included in the virtual avatar live streaming apparatus according to the embodiments of the present disclosure.

In the figures, reference mark 10 indicates electronic device; 12 indicates memory; 14 indicates processor; 20 indicates first terminal; 30 indicates second terminal; 40 indicates backend server; 100 indicates virtual avatar live streaming apparatus; 110 indicates video frame acquiring module; 130 indicates feature point extracting module; 150 indicates facial state controlling module.

### DETAILED DESCRIPTION OF THE EMBODIMENTS

To make the objectives, technical solutions and advantages of the embodiments of the present disclosure clearer, the technical solutions in the embodiments of the present disclosure will be described clearly and completely below with reference to the accompanying drawings in the embodiments of the present disclosure. Obviously, the described embodiments are merely a part of the embodiments of the present disclosure, rather than all the embodiments. Components of the embodiments of the present disclosure, which are generally described and illustrated in the figures herein, may be arranged and designed in a variety of different configurations.

Therefore, the following detailed description of embodiments of the present disclosure provided in the accompanying drawings is not intended to limit the scope of the claimed present disclosure, but merely represents selected embodiments of the present disclosure. Based on the embodiments provided in the present disclosure, all other embodiments, which can be obtained by those of ordinary skill in the art without creative work, shall fall within the protection scope of this application.

It should be noted that like reference numerals and letters denote like items in the following figures, and therefore, once a certain item is defined in one figure, no further definition and explanation thereof is required in the following figures. In the description of the present disclosure, the terms “first,” “second,” “third,” “fourth,” and the like are merely used to distinguish the description and cannot be understood as merely or imply relative importance.

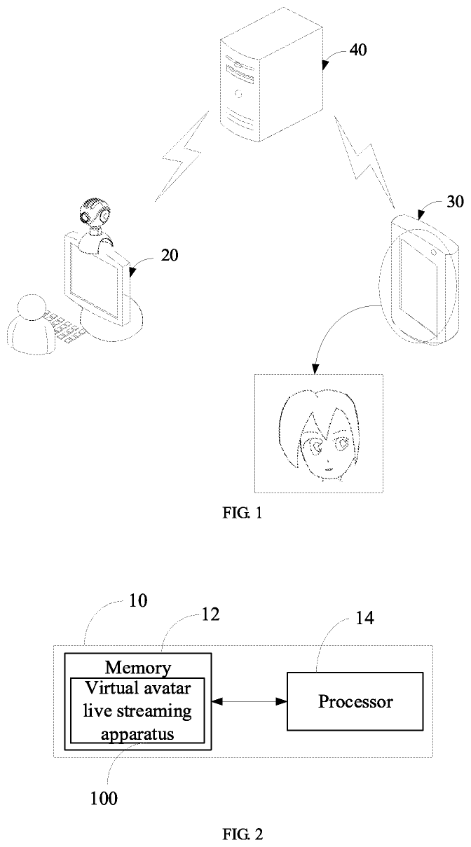

As shown in FIG. 1, a live streaming system is provided according to the embodiments of the present disclosure, which may include a first terminal 20, a second terminal 30 and a backend server 40, where the backend server 40 communicates with the first terminal 20 and the second terminal 30 respectively.

In an embodiment, the first terminal 20 can be a terminal device (such as a mobile phone, a tablet computer, a computer, etc.) used by an anchor during a live streaming, and the second terminal 30 can be a terminal device (such as a mobile phone, a tablet computer, a computer, etc.) used by an audience while watching the live streaming.

With reference to FIG. 2, an embodiment of the present disclosure also provides an electronic device 10. The electronic device 10 may be a live streaming device, for example, the electronic device 10 may be a terminal device (such as the first terminal 20) used by the anchor during the live streaming, or a server (such as the backend server 40) to which the terminal device used by the anchor during the live streaming communicates.

For example, the electronic device 10 may include a memory 12, a processor 14 and a virtual avatar live streaming apparatus 100. The memory 12 and the processor 14 are directly or indirectly electrically connected to realize data transmission or interaction. For example, the memory 12 and the processor 14 can be electrically connected to each other through one or more communication buses or signal lines. The virtual avatar live streaming apparatus 100 may include at least one software function module that may be stored in the memory 12 in the form of software or firmware. The processor 14 may be configured to execute an executable computer program stored in the memory 12, for example, a software function module and a computer program included in the virtual avatar live streaming apparatus 100 to implement the virtual avatar live streaming method provided according to the embodiment of the present disclosure. Furthermore, it is ensured that when the live streaming is performed based on the virtual avatar live streaming method, the facial state of the virtual avatar has better agility to improve the interest of the live streaming, thereby improving the user experience.

The memory 12 may be, but is not limited to, a random-access memory (RAM), a read only memory (ROM), a programmable read-only memory (PROM), an erasable programmable read-only memory (EPROM), an electric erasable programmable read-only memory (EEPROM), etc. The memory 12 may be configured to store a program, and the processor 14 may execute the program after receiving the execution instruction.

The processor 14 may be an integrated circuit chip with signal processing capability. For example, the processor 14 may be a central processing unit (CPU), a network processor (NP), a system on chip (SoC), a digital signal processor (DSP), etc., to implement or execute the methods and steps disclosed in the embodiments of the present disclosure.

It can be understood that the structure shown in FIG. 2 is only for illustration, and the electronic device 10 may also include components more or less than that shown in FIG. 2, or have a configuration different from that shown in FIG. 2, for example, may also include a communication unit configured to perform information interaction with other live streaming apparatus. Each component shown in FIG. 2 can be implemented by hardware, software, or a combination thereof.

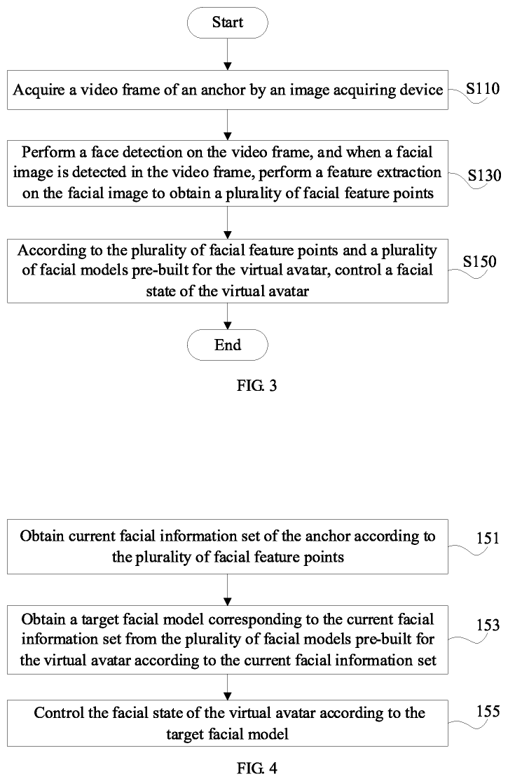

With reference to FIG. 3, the embodiment of the present disclosure also provides a virtual avatar live streaming method, which is applicable to the above electronic device 10, and the electronic device 10 can be used as a live streaming device to control the virtual avatar displayed in the live screen. The method steps defined in the process related to the virtual avatar live streaming method can be implemented by the electronic device 10. The process shown in FIG. 3 will be exemplified below.

At step S110, a video frame of an anchor is acquired by an image acquiring device.

At step S130, a face detection is performed on the video frame, and when a facial image is detected in the video frame, a feature extraction is performed on the facial image to obtain a plurality of facial feature points.

At step S150, according to the plurality of facial feature points and a plurality of facial models pre-built for the virtual avatar, a facial state of the virtual avatar is controlled.

For example, upon the electronic device 10 performing step S110, when the anchor starts the live streaming, the image acquiring device (such as a camera) can acquire images of the anchor in real time to for a video and transmit the video to the connected terminal device.

In an example, if the electronic device 10 that executes the virtual avatar live streaming method is the terminal device, for example, when the electronic device 10 is a terminal device used by the anchor, the terminal device can process the video to obtain the corresponding video frames.

In another example, if the electronic device 10 that executes the virtual avatar live streaming method is the backend server 40, the terminal device may send the video to the backend server 40, so that the backend server 40 can process the video to obtain the corresponding video frames.

In an embodiment, after the electronic device 10 obtains a video frames of the anchor via step S110, the video frame may be an image that includes any part or multiple parts of the anchor's body, and the image may include the facial information set of the anchor, or may not include the facial information set of the anchor (such as a back view image). Therefore, after obtaining the video frame, the electronic device 10 can perform face detection on the video frame to determine whether the video frame includes the facial information set of the anchor. Then, when it is determined that the video frame includes the facial information set of the anchor, that is, when a facial image is detected in the video frame, the feature extraction is performed on the facial image to obtain the plurality of facial feature points.

In some scenes, the facial feature points can be feature points on a face which are high identifiable and pre-labeled. For example, the facial feature points may include, but not limited to, pre-labeled feature points at a lip, a nose, an eye, an eyebrow, etc.

In an embodiment, after obtaining the plurality of facial feature points of the anchor via step S130, the electronic device 10 may determine a target facial model corresponding to the plurality of facial feature points from a plurality of facial models and control the facial state of the virtual avatar according to the based on the facial model.

The plurality of facial models may be pre-built for the virtual avatar, and different facial models may be built for different facial states. For example, the facial models may include, but not limited to, a model of mouth open state, a model of mouth close state, a model of eyes open state, a model of eyes open state, a model of laughing state, a model of sad state, a model of angry state, etc.; therefore, depending on the number of facial states, the number of the built facial models can be 20, 50, 70, 100 and so on.

It can be seen that through the above method provided by the embodiments of the present disclosure, the facial state of the virtual avatar can be synchronously controlled according to the facial state of the anchor during live streaming, so that the facial state of the virtual avatar can reflect the facial state of the anchor to a greater extent, and it can be ensured that the facial state of the virtual avatar can be consistent with the voice or text content output by the anchor so as to improve the user experience.

For example, when the anchor is tired, the anchor says “want to rest”. At this time, the opening extent of the anchor's eyes is generally small. If the opening extend of the virtual avatar's eyes is still relatively large, the user experience may be decreased. In addition, the face states of the anchor generally change a lot during the live streaming. Therefore, controlling the face state of the virtual avatar based on the face states of the anchor can make the face states of the virtual avatar diversified and make the virtual avatar more agile, which increases the interest of the live streaming.

Optionally, in some implementations, the video frame acquired by the electronic device 10 via step S110 may be two-dimensional or three-dimensional. Correspondingly, the image acquiring device can be either a normal camera or a depth camera.

In some scenarios, when the image acquiring device is a depth camera, the facial image may be a depth image, and the depth image may include position information and depth information of each facial feature point. Therefore, when processing based on the facial feature points, the two-dimensional plane coordinates of the facial feature points can be determined based on the position information, and then the two-dimensional plane coordinates are converted into three-dimensional space coordinates in combination with the corresponding depth information.

Optionally, the embodiment of the present disclosure does not limit the specific manner in which the electronic device 10 executes step S150 and can be selected according to actual application requirements. For example, with reference to FIG. 4, as a possible implementation, step S150 may include step 151, step 153, and step 155, and the content of step S150 may be as follows.

At step 151: current facial information set of the anchor is obtained according to the plurality of facial feature points.

It should be noted that the embodiment of the present disclosure does not limit the specific content of the facial information set, and based on different content, the method of obtaining facial information set according to the facial feature points may also be different.

For example, expression analysis can be performed based on the plurality of facial feature points to obtain the current facial expression (such as smiling, laughing, etc.) of the anchor. In an implementation, the facial information set may comprise the facial expression of the anchor.

For another example, the position information or coordinate information of each face feature point may be obtained based on the relative position relationship between the face feature points and the determined coordinate system. That is to say, in another implementation, the facial information set may also comprise the position information or coordinate information of each facial feature point.

At step 153, a target facial model corresponding to the current facial information set is obtained from the plurality of facial models pre-built for the virtual avatar according to the current facial information set.

In some embodiments, after obtaining the current facial information set of the anchor via step 151, the electronic device 10 may obtain a target facial model corresponding to the current facial information set from a plurality of pre-built facial models.

It should be noted that the embodiment of the present disclosure does not limit the specific method of obtaining the target facial model corresponding to the current facial information set from the plurality of facial models. For example, the obtaining method may be different according to the content of the facial information set.

Schematically, in an example, if the facial information set indicates the facial expression of the anchor, the electronic device 10 may store a pre-established correspondence in which facial models correspond to respective facial information sets. In this way, when the electronic device 10 executes step 153, it may obtain the target facial model corresponding to the current facial information set from the plurality of facial models based on a pre-established correspondence.

For example, the pre-established correspondence can be as shown in the following table:

| | |
|---|---|
| Facial expression 1 (such as smiling) | Facial model A |
| Facial expression 2 (such as laughing) | Facial model B |
| Facial expression 3 (such as frowning) | Facial model C |
| Facial expression 4 (such as glaring) | Facial model D |

For another example, the facial information set may comprise the coordinate information of each facial feature point. A matching degree of the coordinate information with respect to each of the plurality of facial models is determined and the facial model for which the matching degree satisfies a preset condition is determined as the target facial model corresponding to the coordinate information.

Schematically, the electronic device 10 may calculate the similarity between each facial feature point and each feature point in the facial model based on the coordinate information and determine the facial model with the greatest similarity as the target facial model. For example, if the similarity with facial model A is 80%, the similarity with facial model B is 77%, the similarity with facial model C is 70%, and the similarity with facial model D is 65%, then the facial model A is determined as the target facial model. Using this similarity calculation, compared to the simple facial expression matching method, the anchor's face and facial model will have a higher matching accuracy. Correspondingly, the content displayed by the virtual avatar is more complied with the current state of the anchor so that the live streaming is more realistic, and the interactive effect is better.

It should be noted that, if the device performing step 153 is a terminal device, when step 153 is performed, the terminal device can retrieve the plurality of facial models from the connected backend server 40.

At step 155, the facial state of the virtual avatar is controlled according to the target facial model.

In an embodiment, after determining the target facial model via step 153, the electronic device 10 can control the facial state of the virtual avatar based on the target facial model. For example, the facial image of the virtual avatar can be rendered based on the target facial model to realize the control of the facial state.

In addition, in some implementations, before performing step S130, the electronic device 10 may also determine the facial feature points that need to be extracted for performing step S130.

As a possible implementation, before performing step S130, the virtual avatar live streaming method may further include the following step: determining the target feature points that need to be extracted for performing a feature extraction.

It should be noted that the method of determining the target feature points in the embodiment of the present disclosure is not limited and can be selected according to actual application requirements. For example, with reference to FIG. 5, as an implementation, determining the target feature points by the electronic device 10 may include step 171, step 173, step 175, and step 177, and the specific content may be as follows.

At step 171, a plurality of facial images of the anchor in different facial states are acquired, and one of the images is selected as a reference image.

In an embodiment, a plurality of facial images of the anchor in different facial states may be acquired first. For example, a facial image can be acquired for each facial state, such as a facial image in a normal state (no expression), a facial image in a smiling state, a facial image in a laughing state, and a facial image in a frowning state, a facial image in a glaring state, and other facial images acquired in advance as needed.

After the plurality of facial images are acquired, one of the facial images can be selected as a reference image, for example, one of all facial images in a normal state can be selected as a reference image, for example, a facial image in a normal state is selected.

It should be noted that, in some implementations, to ensure that the electronic device 10 has high accuracy when determining a target feature point, the plurality of facial images may be a plurality of images taken for the anchor at the same angle, for example, images taken when the camera is facing the face of the anchor.

At step 173, a preset number of personal facial feature points included in each facial image are extracted according to a preset feature extraction method.

In an embodiment, after obtaining the plurality of facial images via step 171, for each facial image, the electronic device 10 may extract a preset number (such as 200 or 240) of facial feature points from the facial image.

At step 175, for each facial image, the extracted facial feature points in the facial image are compared with the extracted facial feature points in the reference image to obtain a respective change value of the facial feature points in the facial image with respect to the facial feature points in the reference image.

In an, after obtaining the facial feature points of each facial image via step 173, for each facial image, the electronic device 10 may compare the extracted facial feature points in the facial image with the extracted facial feature points in the reference image to obtain respective change values of the facial feature points in the facial image with respect to the facial feature points in the reference image.

For example, 240 facial feature points in facial image A can be compared with 240 facial feature points in the reference image to obtain the change value of the 240 facial feature points between facial image A and the reference image (which can be the difference between coordinates).

It should be noted that, to save processor resources, when comparing facial feature points, the facial image used as the reference image may not be compared with the reference image (the change value for the same image is zero).

At step 177, a facial feature point of which the change value is greater than a preset threshold is determined as a target feature point to be extracted in the feature extraction.

In an embodiment, after obtaining the change value of each facial feature point in different images via step 175, the electronic device 10 may compare the change value with a preset threshold value and use the facial feature point of which the change value is greater than the preset threshold value as the target feature point.

For example, for a feature point at the left mouth corner of the anchor, the coordinate of the feature point in the reference image is (0, 0), and the coordinate of the feature point in the facial image A is (1, 0); the coordinate of the feature point in facial image B is (2, 0). Through step 175, the two change values 1 and 2 corresponding to the feature point of the left mouth corner can be obtained. Then, as long as the smallest change value of the two change values is less than the preset threshold (such as 0.5), the feature point at the left mouth corner can be used as a target feature point.

Through the above method, on the one hand, it can be ensured that the determined target feature points can effectively reflect the facial state of the anchor; on the other hand, it can also avoid the high calculation amount of the electronic device 10 during the live streaming due to too many target feature points, which causes a poor real-time performance of the live streaming or a high-performance requirement of the electronic device 10.

In this way, as an implementation, when the electronic device 10 performing step 173 to extract facial feature points, it may only need to extract the determined target feature points to use in subsequent calculations, thereby reducing the calculation amount for the live streaming and improving the fluency of the live streaming.

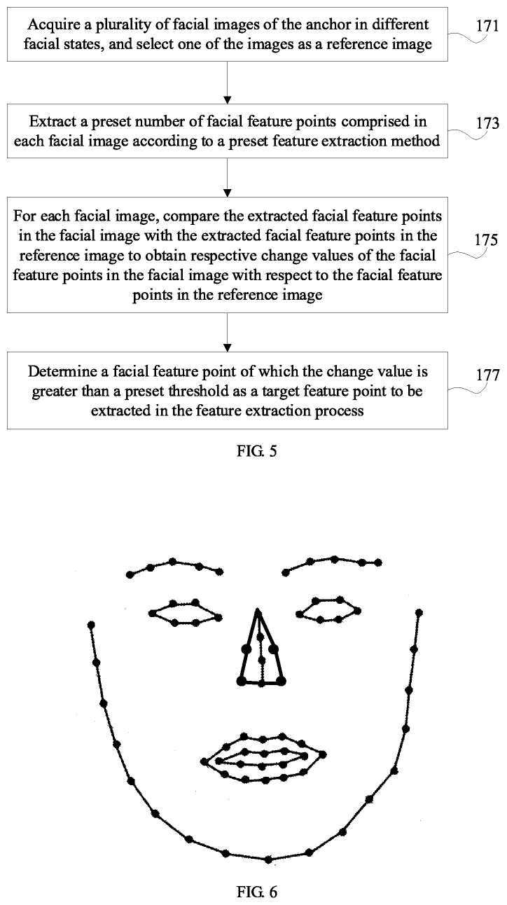

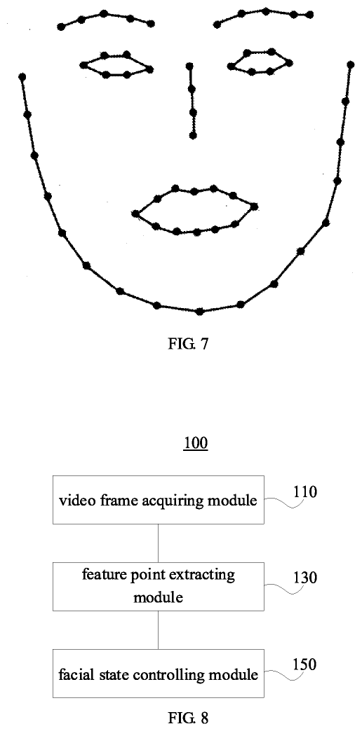

It should be noted that the specific value of the preset threshold can be determined by comprehensively considering factors such as the performance, real-time requirement, and accuracy of facial state control of the electronic device 10. For example, in an implementation, when the facial state control requires higher accuracy, a smaller preset threshold can be set to for a greater number of the determined target feature points (as shown FIG. 6, the nose and the mouth correspond to more feature points). For another example, when a higher real-time performance is required, a larger preset threshold can be set to for a smaller number of the determined target feature points (as shown in FIG. 7, the nose and the mouth correspond to fewer feature points).

Moreover, as another implementation, when the electronic device 10 determining the target feature point, it can also determine the number of target feature points that need to be extracted in the feature extraction according to historical live streaming data of the anchor.

It should be noted that the embodiments of the present disclosure do not limit the specific content of the historical live streaming data. For example, the historical live streaming data may include, but not limited to at least one of the following parameters: a number of virtual gifts to the anchor (for example, the number of virtual gifts can be obtained through all virtual gifts received by the anchor), a live streaming duration of the anchor, a number of bullet-screen comments for the anchor, and a level of the anchor.

For example, if the level of the anchor is higher, the number of target feature points can be greater. Correspondingly, when the streaming is performing a live streaming, the control accuracy for the facial state of the anchor displayed in the live streaming screen is higher, and the experience of audience is better.

In addition, based on the same concept as the above virtual avatar live streaming method provided by the embodiment of the present disclosure, in conjunction with FIG. 8, an embodiment of the present disclosure further provides a virtual avatar live streaming apparatus 100 that can be applied to the above-mentioned electronic device 10. The electronic device 10 can be configured to control the virtual avatar displayed in a live screen. The virtual avatar live streaming apparatus 100 may include a video frame acquiring module 110, a feature point extracting module 130, and a facial state controlling module 150.

The video frame acquiring module 110 may be configured to acquire a video frame of an anchor by an image acquiring device. In an embodiment, the video frame acquiring module 110 may correspondingly perform step S110 shown in FIG. 3, and for related content of the video frame acquiring module 110, reference may be made to the foregoing description of step S110.

The feature point extracting module 130 may be configured to perform a face detection on the video frame, and in response to that a facial image is detected in the video frame, perform a feature extraction on the facial image to obtain a plurality of facial feature points. In an embodiment, the feature point extracting module 130 may correspondingly perform step S130 shown in FIG. 3, and for related content of the feature point extracting module 130, reference may be made to the foregoing description of step S130.

The facial state controlling module 150 may be configured to control a facial state of the virtual avatar based on the plurality of facial feature points and a plurality of facial models pre-built for the virtual avatar. In an embodiment, the facial state controlling module 150 may correspondingly perform step S150 shown in FIG. 3, and for related content of the facial state controlling module 150, reference may be made to the foregoing description of step S150.

In an example, the facial state controlling module 150 may include a facial information obtaining sub-module, a facial model obtaining sub-module, and a facial state controlling sub-module.

The facial information obtaining sub-module may be configured to obtain a current facial information set of the anchor according to the plurality of facial feature points. In an embodiment, the facial information obtaining sub-module may correspondingly perform step 151 shown in FIG. 4, and for related content of the facial information obtaining sub-module, reference may be made to the foregoing description of step 151.

The facial model obtaining sub-module may be configured to, based on the current facial information set, obtain a target facial model corresponding to the current facial information set from the plurality of facial models pre-built for the virtual avatar. In an embodiment, the facial model obtaining sub-module may correspondingly perform step 153 shown in FIG. 4, and for related content of the facial model obtaining sub-module, reference may be made to the foregoing description of step 153.

The facial state controlling sub-module may be configured to control the facial state of the virtual avatar based on the target facial model. In an embodiment, the facial state controlling sub-module may correspondingly perform step 155 shown in FIG. 4, and for related content of the facial state controlling sub-module, reference may be made to the foregoing description of step 155.

In an example, the facial model obtaining sub-module may be specifically configured to: obtain the target facial model corresponding to the current facial information set based on a pre-established correspondence in which facial models correspond to respective facial information sets.

In an example, the facial model obtaining sub-module may also be specifically configured to: determine a matching degree of the current facial information set with respect to each of the plurality of facial models and determine a facial model for which the matching degree satisfies a preset condition as the target facial model corresponding to the current facial information set.

In an example, the facial state controlling sub-module may be specifically configured to render the facial image of the virtual avatar based on the target facial model.

In an example, a virtual avatar live streaming apparatus 100 may further include a feature point determining module. The feature point determining module may be configured to determine a target feature point to be extracted in the feature extraction.

In an example, the feature point determining module may include a facial image acquiring sub-module, a feature point extracting sub-module, a feature point comparing sub-module, and a feature point determining sub-module.

The facial image acquiring sub-module may be configured to acquire a plurality of facial images of the anchor in different facial states and select one of the facial images as a reference image. In an embodiment, the facial image acquiring sub-module may correspondingly perform step 171 shown in FIG. 5, and for related content of the facial image acquiring sub-module, reference may be made to the foregoing description of step 171.

The feature point extracting sub-module may be configured to extract a preset number of facial feature points comprised in each of the facial images based on a preset feature extraction method. In an embodiment, the feature point extracting sub-module may correspondingly perform step 173 shown in FIG. 5, and for related content of the feature point extracting sub-module, reference may be made to the foregoing description of step 173.

The feature point comparing sub-module may be configured to, for each of the facial images, compare the extracted facial feature points in the facial image with the extracted facial feature points in the reference image, so as to obtain respective change values of the facial feature points in the facial image with respect to the facial feature points in the reference image. In an embodiment, the feature point comparing sub-module may correspondingly perform step 175 shown in FIG. 5, and for related content of the feature point comparing sub-module, reference may be made to the foregoing description of step 175.

The feature point determining sub-module may be configured to determine a facial feature point of which the change value is greater than a preset threshold as the target feature point to be extracted in the feature extraction. In an embodiment, the feature point determining sub-module may correspondingly perform step 177 shown in FIG. 5, and for related content of the feature point determining sub-module, reference may be made to the foregoing description of step 177.

In an example, the feature point determining module may include a quantity determining sub-module. The quantity determining sub-module may be configured to determine a number of target feature points to be extracted in the feature extraction based on historical live streaming data of the anchor.

In an example, the historical live streaming data may include one or more of the following: a number of virtual gifts to the anchor; a live streaming duration of the anchor; a number of bullet-screen comments for the anchor, and a level of the anchor.

In an example, the facial image may be a depth image which includes position information and depth information for each of the facial feature points.

In the embodiments of the present disclosure, corresponding to the virtual avatar live streaming method, a computer-readable storage medium is also provided. The computer-readable storage medium stores a computer program. When the computer program is executed, steps in the virtual avatar live streaming methods are implemented.

The steps executed during the running of the computer program will not be repeated here one by one, and reference may be made to the description of the virtual avatar live streaming methods described above.

In some exemplary embodiments provided in the embodiments of the present disclosure, the disclosed methods and procedures can also be implemented in other ways. The method embodiments described above are merely illustrative, for example, flowcharts and block diagrams in the figures show the architecture, functionality, and operation of possible implementations of methods and computer program products according to embodiments of the present disclosure. In this regard, each block in the flowchart or block diagram may represent a module, program segment or portion of code that includes one or more executable instructions for implementing a specified logical function.

It should also be noted that in some alternative implementations, the functions noted in the blocks may also occur in a different order than that noted in the figures. For example, two consecutive blocks may be executed substantially in parallel, and they may also be executed in the reverse order, depending on the functions involved. It is also noted that each block of the block diagrams and/or flowcharts, and combinations of blocks in the block diagrams and/or flowcharts, may be implemented with a dedicated hardware-based system that performs specified functions or acts, or may be implemented with a combination of dedicated hardware and computer instructions.

In addition, the functional modules in the embodiments of the present application may be integrated together to form an independent part, or each module may exist separately, or two or more modules may be integrated to form an independent part.

These functions may be stored in a computer readable storage medium if implemented in the form of software function modules and sold or used as a separate product. Based on such understanding, the technical solutions provided in the embodiments of the present application essentially or in part contributing to the prior art or in part of the technical solutions may be embodied in the form of a software product. The computer software product is stored in a storage medium. comprising several instructions for enabling a computer device (which may be a personal computer, an electronic device, or a network device, etc.) performs all or part of the steps of the method provided by the embodiment of the present application. The foregoing storage medium includes: a USB disk, a removable hard disk, a read-only memory (ROM), a random-access memory (RAM), a magnetic disk, or an optical disk, and any other medium that can store program codes. It should be noted that, in this context, the terms “include”, “comprise” or any other variation thereof are intended to encompass non-exclusive inclusion, such that a process, method, article or device comprising a series of elements includes not only those elements, but also other elements not explicitly listed, or other elements inherent to such a process, method, article or device. If there are no additional restrictions, the element defined by the sentence “including a . . . ” does not exclude the existence of other identical elements in the process, method, article, or equipment that includes the element.

Finally, it should be noted that the above description is merely a part of the embodiments of the present application and is not intended to limit the present disclosure. Although the present application is described in detail with reference to the foregoing embodiments, a person skilled in the art would still have been able to make amendments to the technical solutions described in the foregoing embodiments or make equivalent replacements to some of the technical features thereof. Any amendments, equivalent replacements and improvements made within the spirit and principle of the present application shall all belong to the scope of protection of the present disclosure.

### INDUSTRIAL APPLICABILITY

With the virtual avatar live streaming method, a virtual avatar live streaming apparatus provided in the present disclosure, facial feature points are extracted from real-time facial image of an anchor during a live streaming, and the facial state of the virtual avatar is controlled after calculating the facial feature points. On one hand, it is ensured that the facial state of the virtual avatar has better agility. On the other hand, it is ensured that the facial state of the virtual avatar can be consistent with the actual state of the anchor to improve the interest of the live streaming, thereby improving the user experience.

1. A virtual avatar live streaming method, being applicable to a live streaming device which is configured to control a virtual avatar displayed in a live streaming screen, the method comprises:
acquiring a video frame of an anchor by an image acquiring device;
performing a face detection on the video frame;
in response to that a facial image is detected in the video frame, performing a feature extraction on the facial image to obtain a plurality of facial feature points;
controlling a facial state of the virtual avatar based on the plurality of facial feature points and a plurality of facial models pre-built for the virtual avatar.

2. The virtual avatar live streaming method of claim 1, wherein controlling a facial state of the virtual avatar according to the plurality of facial feature points and a plurality of facial models pre-built for the virtual avatar comprises:
obtaining a current facial information set of the anchor based on the plurality of facial feature points;
based on the current facial information set, obtaining a target facial model corresponding to the current facial information set from the plurality of facial models pre-built for the virtual avatar; and
controlling the facial state of the virtual avatar based on the target facial model.

3. The virtual avatar live streaming method of claim 2, wherein based on the current facial information set, obtaining a target facial model corresponding to the current facial information set from the plurality of facial models pre-built for the virtual avatar comprises:
obtaining the target facial model corresponding to the current facial information set based on a pre-established correspondence in which facial models correspond to respective facial information sets.

4. The virtual avatar live streaming method of claim 2, wherein based on the current facial information set, obtaining a target facial model corresponding to the current facial information set from the plurality of facial models pre-built for the virtual avatar comprises:
determining a matching degree of the current facial information set with respect to each of the plurality of facial models, and
determining a facial model for which the matching degree satisfies a preset condition as the target facial model corresponding to the current facial information set.

5. The virtual avatar live streaming method of claim 2, wherein controlling the facial state of the virtual avatar based on the target facial model comprises:
rendering the facial image of the virtual avatar based on the target facial model.

6. The virtual avatar live streaming method of claim 1, further comprising:
determining a target feature point to be extracted in the feature extraction.

7. The virtual avatar live streaming method of claim 6, wherein determining the target feature point to be extracted in the feature extraction comprises:
acquiring a plurality of facial images of the anchor in different facial states, and
selecting one of the facial images as a reference image;
extracting a preset number of facial feature points comprised in each of the facial images based on a preset feature extraction method;
for each of the facial images, comparing the extracted facial feature points in the facial image with the extracted facial feature points in the reference image to obtain respective change values of the facial feature points in the facial image with respect to the facial feature points in the reference image;
determining a facial feature point of which the change value is greater than a preset threshold as the target feature point to be extracted in the feature extraction.

8. The virtual avatar live streaming method of claim 6, wherein determining the target feature point to be extracted in the feature extraction comprises:
determining a number of target feature points to be extracted in the feature extraction based on historical live streaming data of the anchor.

9. The virtual avatar live streaming method of claim 8, wherein the historical live streaming data comprise one or more of:
a number of virtual gifts to the anchor;
a live streaming duration of the anchor;
a number of bullet-screen comments for the anchor, and
a level of the anchor.

10. The virtual avatar live streaming method of claim 1, wherein the facial image is a depth image which comprises position information and depth information for each of the facial feature points.

11. (canceled)

12. An electronic device, comprising:
a memory,
a processor, and
a computer program stored in the memory and capable of executing on the processor,
wherein, when the computer program is executed on the processor, the following operations are performed:
acquiring a video frame of an anchor by an image acquiring device;
performing a face detection on the video frame;
in response to that a facial image is detected in the video frame, performing a feature extraction on the facial image to obtain a plurality of facial feature points;
controlling a facial state of the virtual avatar based on the plurality of facial feature points and a plurality of facial models pre-built for the virtual avatar.

13. A computer-readable storage medium storing computer program thereon, wherein when the computer program is executed, the following operations are performed:
acquiring a video frame of an anchor by an image acquiring device;
performing a face detection on the video frame;
in response to that a facial image is detected in the video frame, performing a feature extraction on the facial image to obtain a plurality of facial feature points;
controlling a facial state of the virtual avatar based on the plurality of facial feature points and a plurality of facial models pre-built for the virtual avatar.
